(19) United States
(12) Patent Application Publication
(10) Pub. No.: US 2016/0088124 A1
(43) Pub. Date: Mar. 24, 2016

(54) TECHNIQUES FOR VALIDATING PACKETS

(71) Applicants: Ajith Sankar Jayasankar, Bangalor (IN); Navin Kochar, Bangalore (IN); Paritosh Debnath, Bangalore (IN); Mahalingeshwara Chambarakatta, Bangalore (IN); Salai Sivakkani Thirunavukkarsu, Bangalore (IN)

(72) Inventors: Ajith Sankar Jayasankar, Bangalor (IN); Navin Kochar, Bangalore (IN); Paritosh Debnath, Bangalore (IN); Mahalingeshwara Chambarakatta, Bangalore (IN); Salai Sivakkani Thirunavukkarsu, Bangalore (IN)

(21) Appl. No.: 14/494,934

(22) Filed: Sep. 24, 2014

(51) Int. Cl. H04L 29/06; H04L 12/741; H04L 12/24

(52) U.S. Cl. CPC H04L 69/22; H04L 41/0869; H04L 45/74

(57) ABSTRACT

Various embodiments are generally directed to an apparatus, method and other techniques receiving packets each comprising a number of frames, comparing first information in a first frame of a packet with a connection handle established for a communication session, validating the packet when the first information corresponds with the connection handle and discarding the first frame of the packet when the first information does not correspond with the connection handle.

### TECHNICAL FIELD

Embodiments described herein generally relate to techniques for processing packets. More specifically, techniques may include validating packets using at least one of a connection handle and a length for the packets.

### BACKGROUND

Today, many wireless communications systems and devices are being deployed with the capabilities to operate in accordance with Bluetooth®, an industrial specification for wireless personal area networks (PANs) and standardized in the Institute of Electrical and Electronics Engineers (IEEE) 802.15.1 Specification. Bluetooth® provides a protocol for connecting and exchanging information between devices such as mobile phones, laptops, personal computers, printers, and headsets over a secure, globally unlicensed short-range radio frequency.

Generally, the Bluetooth® audio transport mechanism is termed the Synchronous Connection-Oriented (SCO) channel, which supplies full-duplex data with a 64 kbit/s rate in each direction. There are three codecs defined for SCO channels: A-law pulse code modulation (PCM), u-law PCM, and continuous variable slope delta (CVSD) modulation. The CVSD modulation is used almost exclusively due to its robustness to random bit errors. With CVSD modulation, the audio output quality degrades gracefully as the occurrence of random bit errors increases. However, CVSD modulation is not robust to bursty bit errors and interference from other signals, and as a result, annoying “click-like” artifacts may become audible in the audio output. Thus, a need exists to quickly detect packet errors and to validate packets communicated in accordance with Bluetooth®.

### BRIEF DESCRIPTION OF THE DRAWINGS

FIG. 1A illustrates an exemplary embodiment of a system.

FIG. 1B illustrates an exemplary embodiment of a computing device.

FIG. 2 illustrates an exemplary embodiment of a packet.

FIG. 3A illustrates an exemplary embodiment of a packet communication stream.

FIG. 3B illustrates a second exemplary embodiment of a packet communication stream.

FIG. 4 illustrates an exemplary embodiment of a logic flow.

FIGS. 5A/5B illustrate exemplary embodiments of a communication diagram to establish a communication session.

FIG. 6. illustrates an exemplary embodiment of a second logic flow.

FIG. 7 illustrates an exemplary embodiment of a computing system.

FIG. 8 illustrates an exemplary embodiment of a first computing architecture.

### DETAILED DESCRIPTION

Various embodiments are generally directed to an apparatus, system and method for performing packet validation for packets communicated by a computing device in accordance with one or more standards, such as the Institute of Electrical and Electronics Engineers (IEEE) 802.15.1-2005 standard also known as Bluetooth®. The packets may be validated by the computing device, and in particular, a host stack module providing an interface between one or more applications and a controller module. In some instances, the packets may be received by the host stack module and validated based on a connection handle determined for a communication session between the computing device and another device.

For example, the computing device may establish a communication session with another device, such as a peripheral device to communicate information, such as voice data, input data, picture data, and so forth. During the establishment of the communication session, a connection handle may be generated or determined by either the computing device or the other device and saved on the computing device or remotely. The connection handle may then be used to validate packets received by the host stack module based on a comparison between the stored connection handle and information in each of the packets. In particular, each valid packet may include a number frames and a first frame of the packet includes the connection handle. Thus, the host stack module may read information in first frame of a received packet, compare it with the stored connection handle, and determine if there is a match. If a first frame does not contain the connection handle, an error may have occurred, the packet may be out of sync, and the packet will not be validated.

Some embodiments may also be directed to finding the next valid packet when an invalid packet is detected by the host stack module. As will be discussed in the following description, the host stack module may search for the next valid packet on a frame-by-frame basis until a frame is found having a connection handle that matches the stored connection, indicating the start the next valid packet. When searching for the next valid packet, the host control module may discard each frame not having a valid connection handle. These other details will be more fully discussed in the following description.

Various embodiments also relate to an apparatus or systems for performing these operations. This apparatus may be specially constructed for the required purpose or it may include a general-purpose computer as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

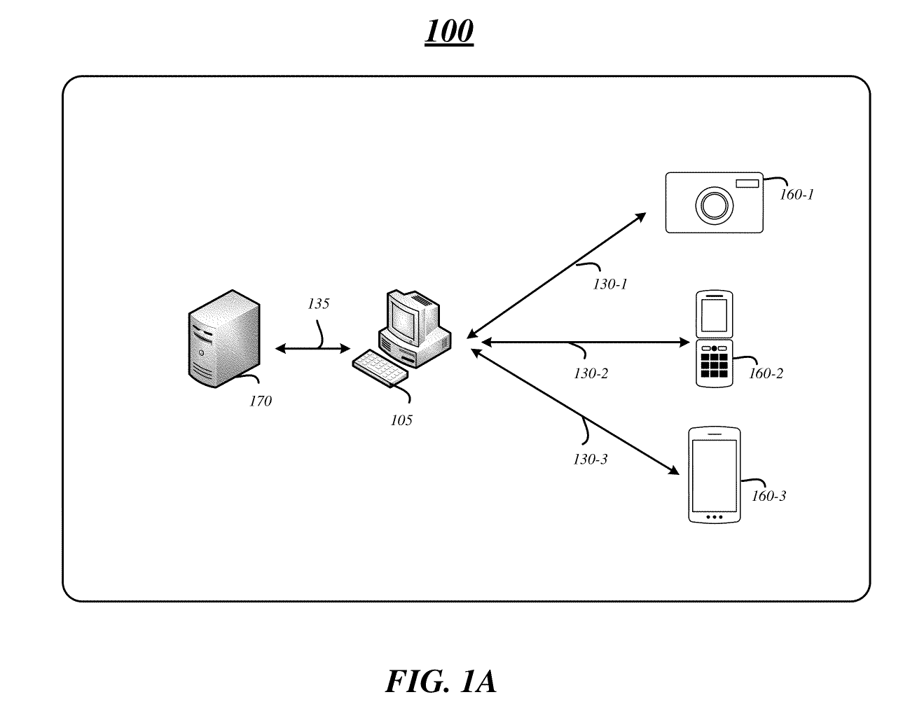

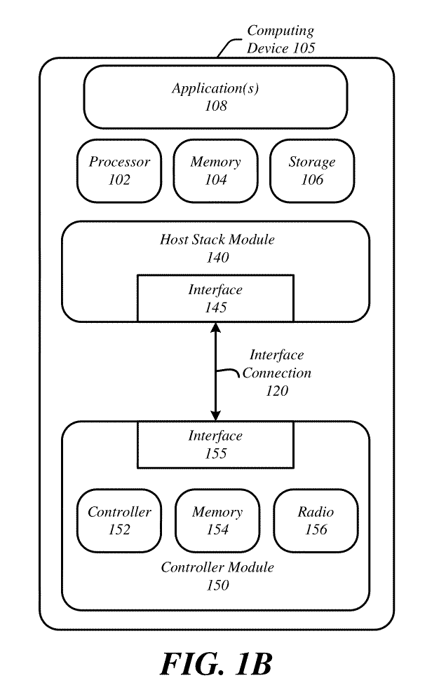

FIG. 1A illustrates an exemplary embodiment of a system 100 for processing information including one or more voice packets. Computing system 100 includes a computing device 105, coupled with a server 170 and peripheral devices 160-1, 160-2 and 160-3. Computing device 105 may be any type of computer or processing device including a personal computer, desktop computer, tablet computer, netbook computer, notebook computer, laptop computer, a mobile computing device, a mobile telephone device, a smartphone device, a personal digital assistant device (PDA), a cellular device, and so forth.

In various embodiments, computing device 105 may be coupled with the server 170 via connection 135 which may include one or more wired or wireless connections. Server 170 of the present disclosure is intended to represent a broad range of server devices. Further, Server 170 may be a single server or a cluster of servers locally and/or remotely coupled via connection 135. Server 170 may also be coupled with one or more storage arrays, such as a network-attached storage system or a storage area network system that include one or more storage devices for storing information that may be accessible to computing device 105.

FIG. 1A also illustrates computing device 105 coupled with peripheral devices 160-1, 160-2 and 160-3 via connections 130-1, 130-2 and 130-3, respectively. Connections 130-1, 130-2 and 130-3 may be any wired or wireless connection capable of communicating information between computing device 105 and a peripheral device 160. In some embodiments, connections 130-1, 130-2 and 130-3 may be one or more short range wireless connections operating in accordance with a wireless communication standard such as the Institute of Electrical and Electronics Engineers (IEEE) 802.15.1-2005 standard also known as Bluetooth®. In these exemplary embodiments, computing device 105 may communicate and process information with a peripheral device 160 in accordance with IEEE 802.15.1. However, various embodiments are not limited in this manner and information may be communicated between computing device 105 and one or more peripheral devices 160 in accordance with any wired or wireless standard.

In various embodiments, peripheral devices 160-1, 160-2 and 160-3 may be any type of device including but not limited to a camera, a camcorder, a wireless telephone, a mobile device, a personal digital assistant (PDA), headphones, hands-free device, a mouse, a keyboard, a printer, a monitor, a scanner, a fax machine, or any other type of device or computing system capable of communicating with another computing device.

Although FIG. 1A illustrates computing device 105 coupled with one server 170 and three peripheral devices 160-1, 160-2 and 160-3, various embodiments are not limited in this manner. Computing device 105 may be coupled with any number of servers and peripheral devices.

FIG. 1B illustrates an exemplary embodiment of computing device 105. FIG. 1B illustrates computing device 105 having a number of components for processing information including one or more packets communicated in accordance with one or more standards. FIG. 1B illustrates computing device 105 having a processor 102, a memory 104, storage 106, one or more application(s) 108, a host stack module 140 and a controller module 150. Further, the host stack module 140 includes an interface 145 coupled with interface 155 of the controller module 150 via interface connection 120. In some embodiments, the controller module 150 may also include a controller 152, a memory 154 and a radio 156. The components and modules of computing device 105 may communicate with each other via one or more interconnects, buses, traces, control lines, data lines, data paths and so forth. Further, although FIG. 1B illustrates computing device 105 having a limited number of components and modules, various embodiments are not limited in this manner. Computing device 105 may have any number of components and modules for processing information.

In various embodiments, computing device 105 includes a processor 102 which may be one or more of any type of computational element, such as but not limited to, processing circuitry including a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. FIG. 1B only illustrates one processor 102. However, various embodiments are not limited in this manner and computing device 105 may include any number of processors having any number of processing cores.

Computing device 105 may also include a memory 104 to couple to processor 102. In various embodiments, the memory 104 may store data and information for system 100 and computing device 105. For example, the memory 104 may store and maintain information such as connection handles for one or more connection and instructions to process information, packets, and so forth. Various embodiments are not limited in this manner and memory 104 may store and maintain other information for processing.

Memory 104 may be implemented using any machine-readable or computer-readable media capable of storing data, including both volatile and non-volatile memory. In some embodiments, the machine-readable or computer-readable medium may include a non-transitory medium. The embodiments are not limited in this context. The memory 104 can store instructions and data momentarily, temporarily, or permanently. The memory 104 may also store temporary variables or other intermediate information while the processor 102 is executing instructions. The memory 104 is not limited to storing the above discussed data and may store any type of data.

Further, computing device 105 may include storage 106 for storing information in a permanent or semi-permanent manner. Storage 106 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 106 may include technology to increase the storage performance enhanced protection for valuable digital media when multiple hard drives are included, for example. Further examples of storage 106 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

The computing device 105 may also include one or more application(s) 108 for processing information. An application 108 may be any type of application for processing information and data including a telephony application, an email application, a social media application, a calendar application, a messaging application, an organizer application, a word processing application, a cloud storage application, a gaming application, and so forth. In some embodiments, the computing device 105 may include an operating system, such as the Microsoft® Windows® Operating System, the Google® the Android® Operating System, the Apple® Operating System, and so forth. In various embodiments, the operating system may provide one or components, modules and so forth to enable the one or more applications 108 to utilizing various hardware components and modules of computing device 105.

In various embodiments, the computing device 105 may include a host stack module 140 for processing information communicated between the computing device 105 and another device, such as a peripheral device 160. More specifically, the host stack module 140 may include software, hardware, or combination of both and implement one or more protocols for communicating information between an application 108 and a peripheral device 160 via the controller module 150. For example, the controller module 150 may include a radio 156 to send and receive packets to the peripheral device 160. The host stack module 140 may receive the packets of information from the controller module 150, process the packets including error detection and validation, and send the information to an application 108 for further processing. The host stack module 140 may also receive information from an application 108, put the information in a format such as packets to communicate to a peripheral device 160, and send the information to the controller module 150 for communicating with the peripheral device 160.

The host stack module 140 may receive and send packets of information to the controller module 150 over interface connection 120. More specifically, the host stack module 140 may include an interface 145 coupled with interface 155 of the controller module 150 via interface connection 120 for communicating the packets. In some embodiments, the interfaces 145 and 155 may communicate the packets over the interface connection 120 in accordance with one or more standards. For example, the interfaces 145 and 155 may be a host controller interface (HCl), such as a universal serial bus (USB) interface or a universal asynchronous receiver/transmitter (UART) interface, and the interface connection may be a HCl transport layer, such as a USB transport layer or a UART transport. The interfaces 145 and 155 may communicate information between the host stack module 140 and the controller module 150 in accordance with a HCl transport layer standard, such as any one of the Universal Serial Bus (USB) industry standards or any one of the Universal Asynchronous Receiver/Transmitter (UART) industry standards based on the type of HCl and HCl transport layer. However, various embodiments are not limited in this manner and different interfaces and transport layers may be used to communicate information.

The host stack module 140 may send and receive one or more packets from the controller module 150 in a format based on the type of interface for interfaces 145 and 155, the type transport layer for interface connection 120 and the type of packet used during a communication session. For example, the interfaces 145 and 155 may be USB interfaces, the interface connection 120 may be a USB transport layer and voice packets may be communicated between the computing device 105 and a peripheral device 160. In this example, voice packets may each be 51 bytes in length including a 3 byte header and 48 bytes of data. In this example, the packets may be further divided into a number of frames based on the type of interface, the type of interface connection, and the type of packet. For example, each voice packet may be communicated in 3 frames each 17 bytes in length. However, various embodiments are not limited in this manner and a different packet communicated over a type different interface may be communicated in a different manner. For example, a packet may be divided into a different number of frames.

The host stack module 140 may also detect errors and validate each packet before they are sent to an application 108 for further processing. As previously mentioned, each packet may include a header including a connection handle for a communication session and a length for a packet. The connection handle may be an identifier used by each packet in a communication session. Moreover, each packet in the same communication session will use the same connection handle. Thus, various embodiments may include saving the connection handle established for the communication session to validate the each packet. The saved connection handle may be compared with each connection handle in the packets, and if they match the packet may be valid. On the other handle, if they do not match then the packet may not be valid

As previously mentioned, a packet may further be divided into a number of frames. In some embodiments, header information may only be included in a first few bytes of a first frame of a packet. Thus, the host stack module 140 may receive the first frame of a packet, read the first few bytes and validate the packet by comparing the information in the first few bytes with the stored connection handle. More specifically, if the information in the first few bytes matches the previously established connection handle for the communication session stored in memory, storage, or remotely, the packet will be validated and sent to the appropriate application for further processing.

In some embodiments, the host stack module 140 may also use the length of the packet in conjunction with the connection handle to validate the packet. The host stack module 140 may compare the length in the first few bytes with a known length for the type of packet communicated during the communication session. In these embodiments, if the length is correct for the type of packet communicated and the connection handle matches the stored connection handle, the packet will be validated. In some embodiments, the host stack module 140 may validate a packet using only the length, only the connection handles, or both.

In some embodiments, the host stack module 140 may find the next valid packet when an error or invalid packet is detected. A packet may become out of sync or one or more frames of a packet may be lost in communication. Thus, various embodiments may be directed to finding a frame with a connection handle matching the stored connection handle and a correct length indicating the start of a valid packet by the host stack module 140.

If a packet is invalid or an error is detected, the host stack module 140 may attempt to find the next valid packet by reading information on a frame-by-frame basis until a valid connection handle and length are found. For example, the host stack module 140 may read the first few bytes of information of a frame and determine if the frame includes a valid connection handle and a valid length for a packet. If not, the host stack module 140 may discard that frame without reading information for the rest of the frame and move to the start of the next frame. The host stack module 140 may analyze the information in the next frame and determine if it has a valid connection handle and a valid length. The host stack module 140 may continue to analyze frames until a frame is found having a valid connection handle and a valid length. When searching for the next valid frame, the host stack module 140 may discard each frame not having a valid connection handle and length as data in these frames will likely cause an error if processed by an application. By searching for valid packets on a frame-by-frame basis instead of reading each received byte, significant processing cycles and power may be saved because the number of reads to find the next valid packet will be reduced.

As previously mentioned, the computing device 105 may also include a controller module 150 for establishing a link between the computing device 105 and another device, controlling communication channels to communicate information, and communicating information. In some embodiments, the controller module 150 may operate and communicate in accordance with one or more standards. For example, the controller module 150 may be a Bluetooth® host controller and operate in accordance with 802.15.1. However, the controller module 150 is not limited in this manner and may operate in accordance with other standards, such as the IEEE 802.11 standard, any IEEE 802.15 standard, the IEEE 802.16, or any other standard.

The controller module 150 may include a number of components including a controller 152 for establishing a link and controlling communication channels. Further, the controller module 150 may include a memory 154 to store information and a radio 156 to communicate information between devices. The controller module 150 may also include interface 155 to communicate information and data with interface 145 of the host stack module 140. The controller module 150 may not be limited to components illustrated in FIG. 1B and may include more or less components to process information.

The controller module 150 including the controller 152 may establish a link between the computing device 105 and another device, such as a peripheral device 160. For example, an application 108 or a peripheral device 160 may generated a communication session request message which may be communicated to the host stack module 140. In response to receiving the communication session request message, the host stack module 140 may initiate a communication session and may send a connection request message to the controller module 150 and controller 152. The controller 152 may receive the connection request message and may establish a connection between the computing device 105 and another device based on the connection request message. More specifically, the controller 152 may process the connection request message and forward the connection request message to another device, such as a peripheral device 160 via the radio 156. In some embodiments, the controller 152 may include a connection handle with the connection request message sent to the peripheral device 160.

The radio 156 may receive a connection response message from the peripheral device 160 and the controller 152 may establish a link and a communication session with the peripheral device 160. In some embodiments, the controller 152 may not have communicated a connection handle to the peripheral device 160 with the connection request message and the peripheral device 160 may include a connection handle with the connection response message. In either case, when the controller 152 or peripheral device generate the connection handle, the controller 152 may forward the connection response message including the connection handle to the host stack module 140. As previously discussed, the host stack module 140 may save the connection handle for validation of packets.

Once a link and communication session are established, the controller 152 may control communication between the devices. More specifically, the controller 152 may process packets including information and data to communicate with another device. For example, the controller 152 may receive packets from the host stack module 140 and may send the packets to the other device via radio 156. In some embodiments, the controller 152 may format the packets in a particular manner and in accordance with one or more standards. More specifically, the controller 152 may receive the packets in one format, such as in accordance with an HCl transport layer standard, and may convert or transform the packets for communication prior to transmission to other device via radio 156. The controller 152 may also receive packets including information and data from another device via the radio 156 and may send the received packets to the host stack module 140 in a format in accordance with an HCl transport layer standard, as previously discussed.

In various embodiments, the controller module 150 may include a separate memory 154 to use when sending and receiving packets. More specifically, memory 154 may be used a buffer to buffer packets received from another device, such as a peripheral device 160, waiting to be processed and packets to send to the device. Memory 154 may be the similar to memory 104. For example, memory 154 may be implemented using any machine-readable or computer-readable media capable of storing data, including both volatile and non-volatile memory. In some embodiments, the machine-readable or computer-readable medium may include a non-transitory medium. In some embodiments, memory 154 may be the same memory as memory 104.

Further, controller module 150 may include a radio 156 for communicating information. Radio 156 may be any type of communication device capable of sending and receiving information over a wired or wireless connection. Radio 156 may include hardware components, such as a transmitter and a receiver to communicate the information. In some embodiments, the radio 156 may be coupled with one or more antennas (not shown) to communicate information wirelessly to other devices, such as a peripheral device 160. In various embodiments, the radio 156 may operate in accordance with any standard including, but not limited into 802.15.1.

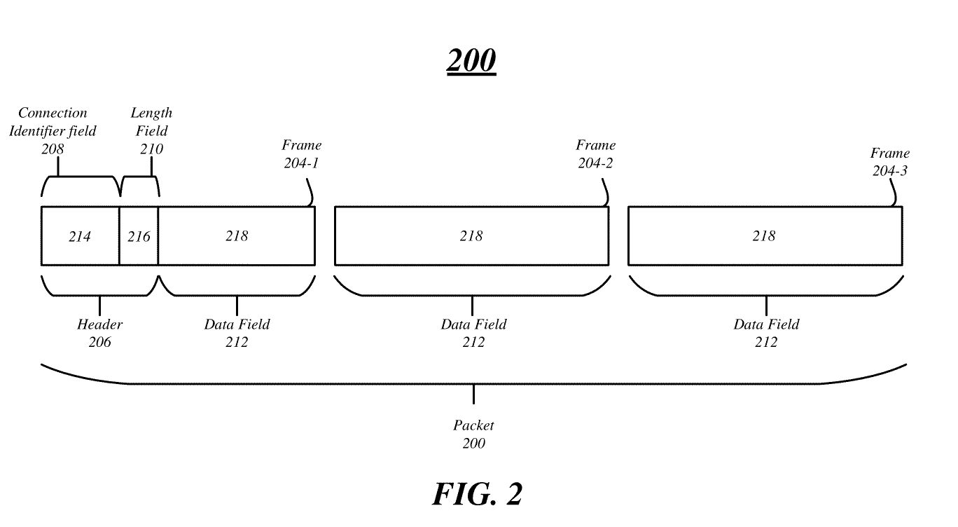

FIG. 2 illustrates an exemplary embodiment of a packet 200 that may be communicated between devices, such as computing device 105 and a peripheral device 160. In various embodiments, packet 200 may be any type of packet and may include any type of information and data. For example, packet 200 may include voice information and voice data and may be a voice packet. However, various embodiments are not limited in this manner and packet 200 may include other information and data such as input data, printer data, fax data, telephony data, and so forth.

As previously discussed, packets, such as packet 200, may be communicated between the host stack module 140 and the controller module 150 during the communication session between the devices. When communicating the packets between the host stack module 140 and controller module 150, they may need to be formatted in a particular manner, such as in accordance with an HCl transport layer standard. FIG. 2 illustrates an exemplary embodiment of packet 200 divided into frames 204-1, 204-2 and 204-3 in accordance with an HCl transport layer standard, such as the USB industry standard. The frames 204-1, 204-2 and 204-3 may be adjacent or adjoining frame and each have a data field 212. Further, the first frame 204-1 has a header 206 including a connection identifier field 208 and a length field 210. Although FIG. 2 illustrates packet 200 divided into 3 frames various embodiments are not limited in this manner and different types of packets may include a different number of frames divided differently. Moreover, packets may be divided into a different manner based on a different HCl transport layer standard selected for communicating the packet the host stack module 140 and the controller module 150.

In various embodiments, the packet 200 may include the data field 212 having data 218, the connection identifier field 208 may have a 2 byte connection handle 214 for a communication session, and the length field 210 may have a 1 byte length 216. Thus, the header 206 may include a total of 3 bytes of information. In one example, packet 200 may be a voice packet having 48 bytes of data 216. Thus in this example, the total length of packet 200 may be 51 bytes, 48 bytes of data 216, 2 bytes for the connection handle and 1 byte for the length.

As previously discussed, the connection handle 214 and the length 216 may be used to detect errors and validate packets by the host stack module 140. For example, the connection handle 214 communicated in the connection identifier field 208 may be compared to the saved connection handle established for a communication session to determine if the packet is valid. In addition, the length 216 in the length field 210 may be compared to a known packet length for a packet to further validate the packet.

Once a packet is validated, the data 218 in the validated packet may be sent to an application for further processing. For example, the data 218 may be voice data in a voice packet and may be processed by a telephony application on a mobile device. In another example, the data 218 may be input received by an input peripheral device that may be processed by a texting application. Various embodiments are not limited to these examples.

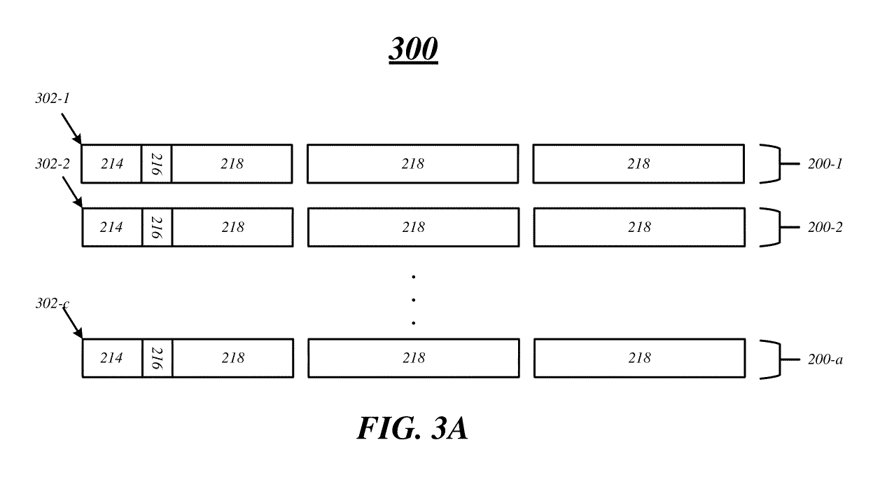

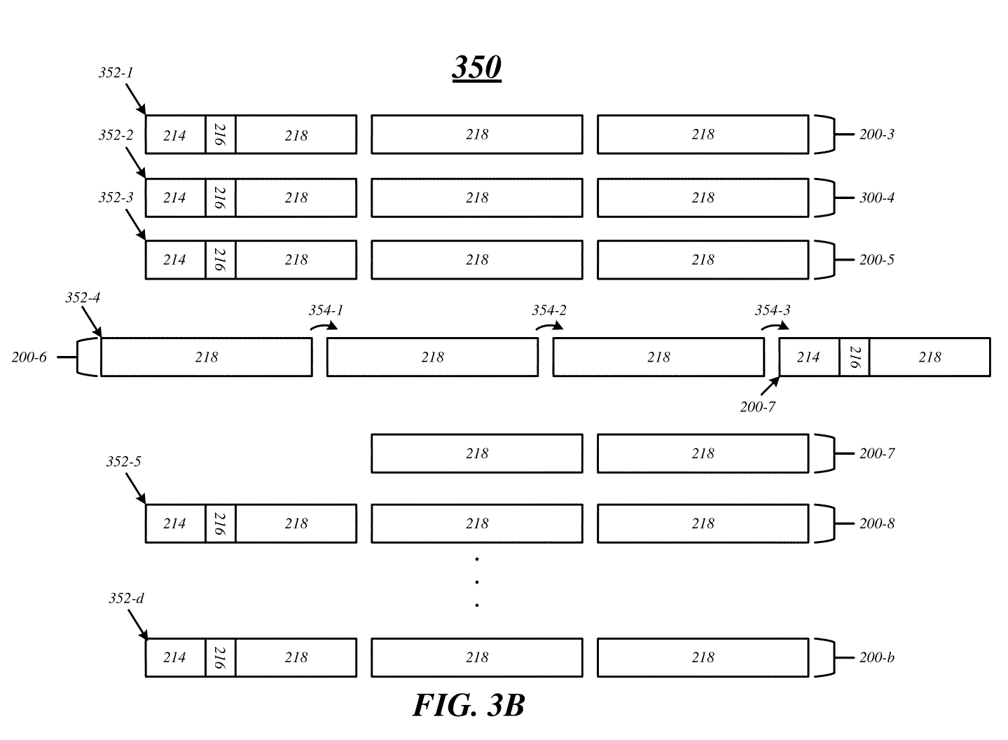

FIG. 3A illustrates an exemplary embodiment of a packet communication stream 300 for a number of packets received over time. For clarity purposes, the packet communication stream 300 is discussed with reference to the computing system 100 and computing device 105 of FIGS. 1A and 1B and packet 200 of FIG. 2. Packets 200-1 through 200-a, where a may be any positive integer, may be packets received by a host stack module 140 from a controller module 150. Moreover, packets 200-1 through 200-a may include information received by computing device 105 from another device, such as peripheral device 160.

The host stack module 140 may receive each packet from the controller module 150 via the interface connection 120 in accordance with an HCl transport layer standard. In various embodiments, the host stack module 140 may validate each packet by reading a connection handle 214 from a connection identifier field 208 and comparing it to a stored connection handle established for a communication session. The host stack module 140 may further validate a packet by reading a length 216 from a length field 210 and comparing it to a known length for a type packet to be communicated between devices.

FIG. 3A illustrates a host stack module 140 reading the information from the connection identifier field 208 and length field 210 for each packet at lines 302-1 through 302-a. In this exemplary embodiment, each packet 200-1 through 200-a is valid and is validated by the host stack module 140.

FIG. 3B illustrates a second exemplary embodiment of a packet communication stream 350 for a number of packets received over time. Packet communication stream 350 is also discussed with reference to the computing system 100, computing device 105, and packet 200. Packet stream 350 illustrates an exemplary embodiment of the host stack module 140 receiving a number of packets 200-3 through 200-b, where b may be any positive integer, from the controller module 150. The packets 200-3 through 200-b may include information from another device, such as a peripheral device 160.

As similarly discussed, each packet 200 may be received and validated by the host stack module 140. More specifically, the host stack module 140 may read information from each packet as indicated by lines 352-1 through 352-d, where d may be any positive integer. The information read from each packet may be a connection handle 214 in a connection identifier field 208 and a length 216 in a length field 210. Each packet 200-3 through 200-b may be validated by comparing the connection handle 214 with a stored connection handle. Further, the length 216 for each packet 200-3 through 200-b may also be compared to a known length for the packets 200. When the connection handle 214, the length 216, or both are correct the packet 200 may be validated.

FIG. 3B illustrates packets 200-3, 200-4, 200-5, 200-7 and 200-8 as being valid packets. However, packet 200-6 is out of sync and is invalid based on the information read at line 352-4. As illustrated in FIG. 3B, the host stack module 140 will read data 218 at line 352-4 and, therefore, packet 202-6 will not be validated because it will not include a correct connection handle and/or length.

When an invalid packet is detected, the host stack module 140 may discard the frame having the incorrect information. Further, the host stack module 140 may search for the next valid packet on a frame-by-frame basis. For example, FIG. 3B illustrates the host stack module 140 moving to the next frame boundary, discarding the previous frame, and reading information from the next frame as indicated by line 354-1. However, the next frame does not have a correct connection handle and length. The host stack module 140 may move to the next frame, discard the previous frame and may read information as indicated by line 354-2. Similarly, the host stack module 140 has not located the next valid packet and the host stack module 140 may move to the next frame. At line 354-3, the host stack module 140 will read a valid connection handle 214 and length 216 indicating the beginning on the next valid packet, packet 200-7 in this example.

Although FIG. 3B illustrates the host stack module 140 finding the next valid packet after reading information from 3 frames, any number of frames may be read until a valid packet is found. The host stack module 140 may discard each frame of an invalid packet, as information in these frames will likely cause an erroneous output. The host stack module 140 may continue to validate packets and search for valid packets when errors are detected for any number of packets. Various embodiments are not limited in the number of packets in which the host stack module 140 may validate.

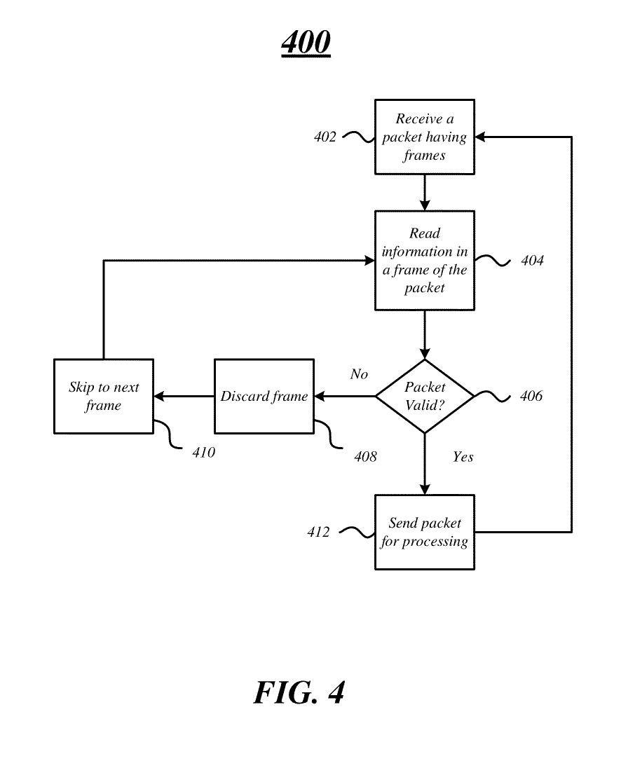

FIG. 4 illustrates a first logic flow 400 for validating packets. Logic flow 400 may be representative of some or all of the operations executed by one or more embodiments described herein. For example, the logic flow 400 may illustrate operations performed by the systems 100, 700 and 800 and computing device 105. For clarity, logic flow 400 is discussed with reference to system 100 and computing device 105 of FIGS. 1A and 1B. However, various embodiments are not limited in this manner and other systems, devices, components and so forth may perform the operations discussed with respect to logic flow 400.

At block 402, a packet having one or more frames may be received by a host stack module 140. In some embodiments, the host stack module 140 may receive the packet from a controller module 150 via an interface connection 120. The packet may be sent to the host stack module 140 in accordance to one or more communication standards. For example, interfaces 145 and 155 may be coupled via interface connection 120 and operate in accordance with an HCl transport layer standard. In this example, the packet may be communicated to the host stack module 140 in accordance with a Universal Serial Bus (USB) industry standard or a Universal Asynchronous Receiver/Transmitter (UART) industry standard.

In some embodiments, the packet may be received by the host stack module 140 as a number of frames based on the HCl transport layer standard used to communicate the packets. For example, the packet may be received as a number of frames each having a length of 17 bytes when the packet is communicated using the USB industry standard. However, various embodiments are not limited in this manner and the packet may be communicated in a different manner under a different standard.

The host stack module 140 may receive the packet and read information from the first few bytes of one of the frames of the packet at block 404. The first few bytes may be a header further divided into a connection identifier field and a length field. The information read may include a connection handle for a communication session and a length for the packet. If this is the first time reading information for the packet, the host stack module 140 may read the information from the first frame of the packet. However as will be discussed in more detail below, the host stack module 140 may read information from subsequent frames when the first frame does not include a valid connection handle and length.

At decision block 406, the host stack module 140 may determine whether the packet is valid based on the information read at block 404. In particular, the host stack module 140 may compare the information read from the packet with a stored connection handle established for a communication session. When the information matches the stored connection handle for the communication session, the packet may be validated. Further, the host stack module 140 may determine if information includes a valid length for the packet based on a known packet length for the communication session. In some cases, a packet may only be validated when the information includes both the correct connection handle and the correct length.

If the packet is valid at decision block 406, the host stack module 140 may send the packet including the remaining frames to an application for further processing at block 412. Blocks 402 through 412 may be repeated for each subsequent packet received by the computing device 105 and the host stack module 140. However, if the packet is not valid at block 406, the host stack module 140 may search for the next valid packet on a frame-by-frame basis. In particular and at block 408, the host stack module 140 may discard the frame having the incorrect information and skip to the next frame in the packet at block 410.

The host stack module 140 may again read information from next or subsequent frame received at block 404 and determine if the packet is valid at decision block 406. Blocks 404 through 410 may be repeated any number of times for any number of frames until the next valid packet is received and determined at block 406. Once a valid packet is found, the packet may be sent to an application at block 412 as previously discussed.

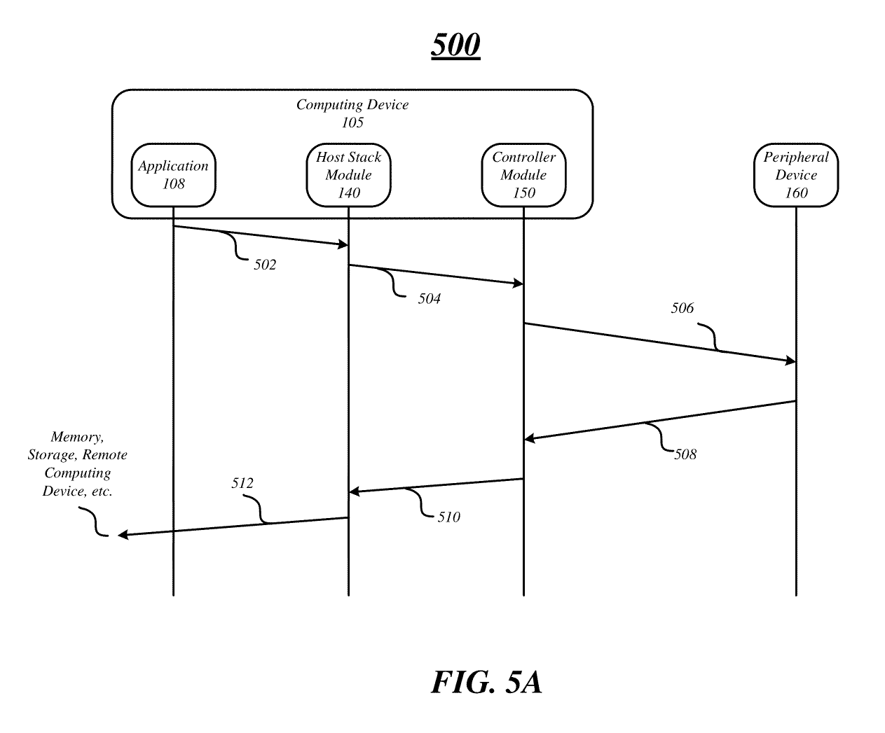

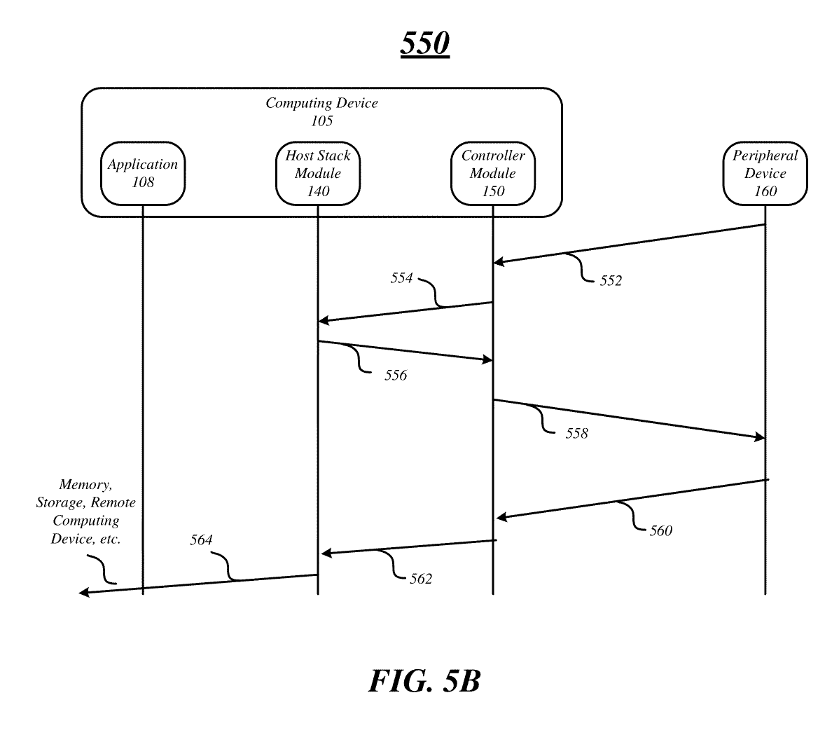

FIGS. 5A/5B illustrate exemplary embodiments of communication diagrams 500 and 550 for establishing communication sessions between a computing device 105 and a peripheral device 160. More specifically, FIG. 5A illustrates the establishment of a communication session based on a request sent from an application 108 and FIG. 5B illustrates the establishment of a communication session based on a request sent from the peripheral device 160.

FIG. 5A illustrates Application 108 sending a communication session request message to the host stack module 140 to establish a communication session at line 502. The communication session request message may include information such as an identification of a targeted device and the type of communication for the communication session. For example, the identification may include an identification (ID) number or an address and the type of communication may be data, voice, video, audio, and so forth. Various embodiments are not limited to these examples.

The host stack module 140 may receive the message and generate a connection request message based on the information received from the application 108. The connection request message may also include information such as the identification of the targeted device and the type of communication session to establish. The host stack module 140 may send the connection request to the controller module 150 at line 504 which may forward the connection request message to a peripheral device 160 at line 506. The peripheral device 160 may be selected based on the identification in the connection request message. In some embodiments, the controller module 150 may also include additional information with the connection request, such as a channel and a connection handle for communication session.

The peripheral device 160 may receive the connection request message and generate a connection response message based on the connection request message. At line 508, the peripheral device 160 may send the connection response message to the controller module 150. The connection response message may indicate the acceptance or declination of the establishment of the communication session. Further, the controller module 150 may send or forward the connection response message to the host stack module 140 at line 510. In some embodiments, the controller module 150 may also send the connection handle with the connection response message to the host stack module 140. The host stack module 140 may receive the connection response message and connection handle and may save the connection handle at line 512. In some embodiments, the host stack module 140 may save the connection handle in memory, storage, or remotely. Once a communication session is established, the application 108 may communicate with the peripheral device 160 via the host stack module 140 and the controller module 150 using the connection handle. Further and as previously discussed, the host stack module 140 may validate packets based on the connection handle and length of the packet.

As previously mentioned FIG. 5B illustrates an exemplary embodiment of a peripheral device 160 initiating a communication session. In some embodiments, the peripheral device 160 may send a communication session request message to the computing device 105 and, in particular, the controller module 150 at line 552. The communication session request may include information such as the requesting peripheral device's identity and a type of communication session desired. The control module 150 may receive the communication session request and forward it to the host stack module 140 at line 554 for further processing. The host stack module 140 may generate and send a connection request message to the controller module 150 at line 556 to establish a communication session with the peripheral device 160. The connection request message may include information, such as the identification of the peripheral device and the type of communication session desired. The controller module 150 may forward the connection request message to the peripheral device at line 558 and may include a connection handle to use in the communication session.

The peripheral device 160 may receive the connection request message, generate a connection response message and send the connection response message back to the controller module 150 at line 560. The connection response may include an acceptance or declination to establish the communication session. The controller module 150 may send or forward the connection response to the host stack module 140 at line 562. In some embodiments, the controller module 150 may also send the connection handle with the connection response to the host stack module 140. The host stack module 140 may receive the connection response and the connection handle and may save the connection handle at line 564. In some embodiments, the host stack module 140 may save the connection handle in memory, storage, or remotely. Once a communication session is established, the application 108 may communicate with the peripheral device 160 via the host stack module 140 and the controller module 150 using the connection handle. Further and as previously discussed, the host stack module 140 may validate packets based on the connection handle and length of the packet.

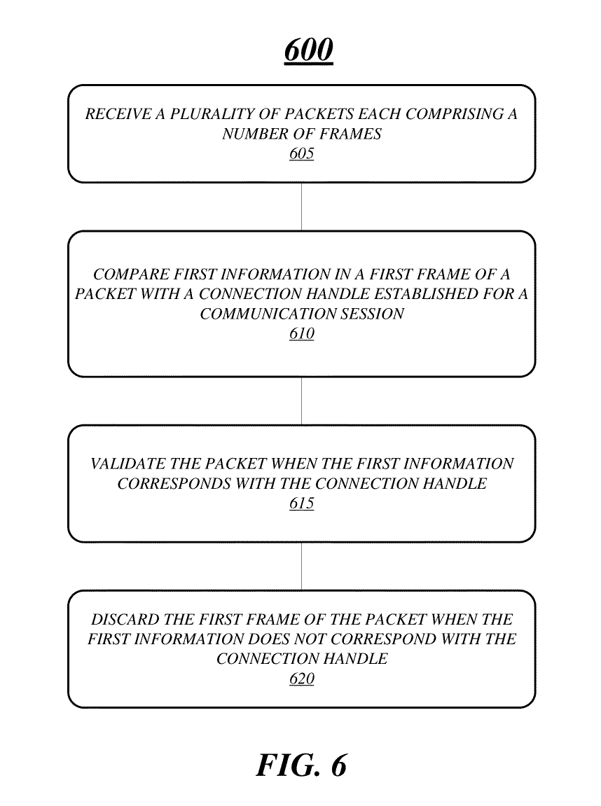

FIG. 6 illustrates an embodiment of logic flow 600. The logic flow 600 may be representative of some or all of the operations executed by one or more embodiments described herein. For example, the logic flow 600 may illustrate operations performed by the system 100, computing device 105, and so forth.

In the illustrated embodiment shown in FIG. 6, the logic flow 600 may include receiving a plurality of packets each comprising a number of frames. For example, in some embodiments a host stack module 140 may receive packets from a controller module 150 for processing. The packets may be based on information received from a peripheral device 160 by the controller module 150 through a radio 156 and further communicated to the host stack module 140 via a connection interface 120. In some embodiments, the host stack module 140 may receive the packets through interface 145 in accordance with a HCl transport layer standard.

More specifically, the controller module 150 may format the packets prior to sending them to the host stack module 140 to be transmitted over the interface connection 120. The packets may be put into a format based on the HCl transport layer standard for the interface connection 120. In one example, the packets may be voice packets communicated to the host stack module over a USB transport layer. In this example, each packet may be divided into a number of frames, such as 3 frames for a voice packet that is 51 bytes in length. However various embodiments are not limited to this example, and the controller module 150 may put the packets into the correct format based on the HCl transport layer used for communicating the packets.

At block 610, the logic flow 600 may include comparing first information in a first frame of a packet with a connection handle established for a communication session. As previously mentioned, each packet may be further divided into a number of frames and when the packet is valid, the first frame may include a header having information, such as a connection handle for a communication session and a length for the packet. The connection handle may be the same for every packet that is being communicated during the communication session and is used to identify the communication session. The connection handle may have been previously established when the communication session was created as similarly discussed above with respect to FIGS. 5A and 5B, or at some other time. The connection handle previously established may be saved in memory, storage or remotely and be used to compare against information in each packet for validation.

For example, logic flow 600 may include validating the packet when the first information corresponds with the connection handle at block 615. Further, the logic flow 600 may also include discarding the first frame of the packet when the first information does not correspond with the connection handle at block 620. When the packet is validated, it may be sent to an application for further processing. However, if the first frame does not include information that matches or corresponds with the connection handle, the first frame may be discarded and subsequent frames may be analyzed to find the beginning of the next valid packet.

In some embodiments, the length of the packet in the first frame may also be used to further validate the packet. For example, if both the connection handle matches the stored connection handle and the length of the packet is correct the packet may be validated. However, various embodiments are not limited in this manner and in some embodiments, the length alone may be used to validate a packet.

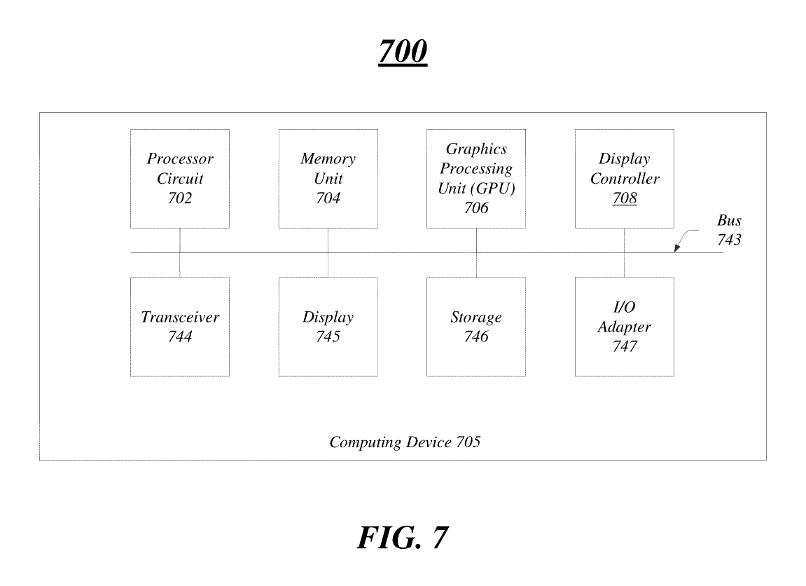

FIG. 7 illustrates one embodiment of a system 700. In various embodiments, system 700 may be representative of a system or architecture suitable for use with one or more embodiments described herein, such as system 100 of FIG. 1. The embodiments are not limited in this respect.

As shown in FIG. 7, system 700 may include multiple elements. One or more elements may be implemented using one or more circuits, components, registers, processors, software subroutines, modules, or any combination thereof, as desired for a given set of design or performance constraints. Although FIG. 7 shows a limited number of elements in a certain topology by way of example, it can be appreciated that more or less elements in any suitable topology may be used in system 700 as desired for a given implementation. The embodiments are not limited in this context.

In various embodiments, system 700 may include a computing device 705 which may be any type of computer or processing device including a personal computer, desktop computer, tablet computer, netbook computer, notebook computer, laptop computer, server, server farm, blade server, or any other type of server, and so forth.

Other examples of computing device 705 also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a computing device 705 may be implemented as a smart phone capable of executing computer applications, as well as voice communications and/or data communications. Although some embodiments may be described with a computing device 705 implemented as a smart phone by way of example, it may be appreciated that other embodiments may be implemented using other wireless computing devices as well. The embodiments are not limited in this context.

In various embodiments, computing device 705 may include processor circuit 702. Processor circuit 702 may be implemented using any processor or logic device. The processing circuit 702 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. The processing circuit 702 may be connected to and communicate with the other elements of the computing system via an interconnect 743, such as one or more buses, control lines, and data lines.

In one embodiment, computing device 705 may include a memory unit 704 to couple to processor circuit 702. Memory unit 704 may be coupled to processor circuit 702 via communications bus 743, or by a dedicated communications bus between processor circuit 702 and memory unit 704, as desired for a given implementation. Memory unit 04 may be implemented using any machine-readable or computer-readable media capable of storing data, including both volatile and non-volatile memory. In some embodiments, the machine-readable or computer-readable medium may include a non-transitory medium. The embodiments are not limited in this context.

Computing device 705 may include a graphics processing unit (GPU) 706, in various embodiments. The GPU 706 may include any processing unit, logic or circuitry optimized to perform graphics-related operations as well as the video decoder engines and the frame correlation engines. The GPU 706 may be used to render 2-dimensional (2-D) and/or 3-dimensional (3-D) images for various applications such as video games, graphics, computer-aided design (CAD), simulation and visualization tools, imaging, etc. Various embodiments are not limited in this manner; GPU 706 may process any type of graphics data such as pictures, videos, programs, animation, 3D, 2D, objects images and so forth.

In some embodiments, computing device 705 may include a display controller 708. Display controller 708 may be any type of processor, controller, circuit, logic, and so forth for processing graphics information and displaying the graphics information. The display controller 708 may receive or retrieve graphics information from one or more buffers, such as buffer(s) 220. After processing the information, the display controller 708 may send the graphics information to a display.

In various embodiments, system 700 may include a transceiver 744. Transceiver 744 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 744 may operate in accordance with one or more applicable standards in any version. The embodiments are not limited in this context.

In various embodiments, computing device 705 may include a display 745. Display 745 may constitute any display device capable of displaying information received from processor circuit 702, graphics processing unit 706 and display controller 708.

In various embodiments, computing device 705 may include storage 746. Storage 746 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 746 may include technology to increase the storage performance enhanced protection for valuable digital media when multiple hard drives are included, for example. Further examples of storage 746 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, computing device 705 may include one or more I/O adapters 747. Examples of I/O adapters 747 may include Universal Serial Bus (USB) ports/adapters, IEEE 1394 Firewire ports/adapters, and so forth. The embodiments are not limited in this context.

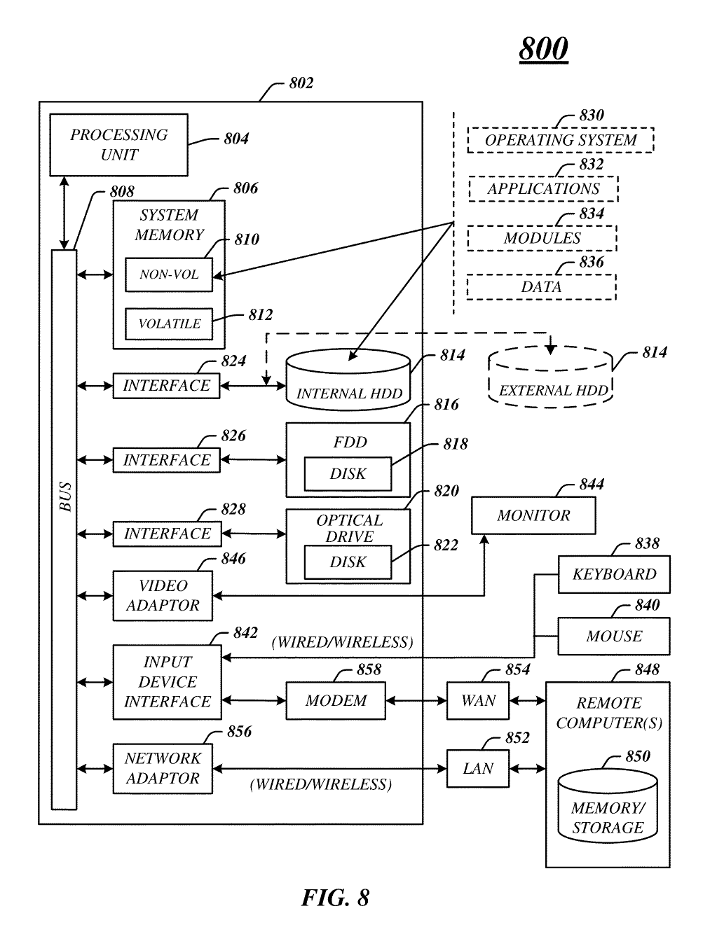

FIG. 8 illustrates an embodiment of an exemplary computing architecture 800 suitable for implementing various embodiments as previously described. In one embodiment, the computing architecture 800 may include or be implemented as part of systems 100.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 includes a processing unit 804, a system memory 806 and a system bus 808. The processing unit 804 can be any of various commercially available processors.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 700.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the system 100, 700 and 800 and computing device 105 as previously described with reference to FIGS. 1-8 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The detailed disclosure now turns to providing examples that pertain to further embodiments. Examples one through thirty (1-30) provided below are intended to be exemplary and non-limiting.

In a first example, a system or an apparatus may include processing circuitry, a memory coupled with the processing circuitry to store a connection handle for a communication session, a controller module comprising a radio to communicate information. The system or apparatus may also include a host stack module coupled with the controller module via an interface connection, the host stack module to, receive packets from the controller module, each packet comprising a number of frames, compare first information in a first frame of a packet with the connection handle stored in the memory, and validate the packet when the first information corresponds with the connection handle, or discard the first frame when the first information does not correspond with the connection handle.

In a second example and in furtherance of the first example, the system or apparatus may include the host stack module to compare information in each subsequent frame with the connection handle in the memory until the information corresponds with the connection handle, and discard each subsequent frame that does not have information corresponding with the connection handle.

In a third example and in furtherance of any of the previous examples, the system or apparatus may include, the host stack module to further validate the packet when second information in the first frame of the packet corresponds with a correct length for the packet.

In a fourth example and in furtherance of any of the previous examples, the system or apparatus may include the host stack module to determine whether information in subsequent frames corresponds with the connection handle on a frame-by-frame basis skipping remaining bytes in each subsequent frame when the information does not correspond with the connection handle.

In a fifth example and in furtherance of any of the previous examples, the system or apparatus may include the host stack module to determine the connection handle for the connection from a connection response message communicated to establish the communication session.

In a sixth example and in furtherance of any of the previous examples, the system or apparatus may include the first frame comprising a header further comprising a 2 byte connection identifier field having the first information and a 1 byte length field having second information.

In a seventh example and in furtherance of any of the previous examples, the system or apparatus may include the controller module to establish the communication session with a peripheral device and communicate with the peripheral device during the communication session via the radio.

In an eighth example and in furtherance of any of the previous examples, the system or apparatus may include the host stack module comprising a first interface and the controller module comprising a second interface, the first and second interfaces to communicate packets between the host stack module and the controller module in accordance with a host controller interface (HCl) transport layer standard.

In a ninth example and in furtherance of any of the previous examples, a computer-implemented method may include receiving, by processing circuitry, packets each comprising a number of frames, comparing, by the processing circuitry, first information in a first frame of a packet with a connection handle established for a communication session, validating, by the processing circuitry, the packet when the first information corresponds with the connection handle and discarding, by the processing circuitry, the first frame of the packet when the first information does not correspond with the connection handle.

In a tenth example and in furtherance of any of the previous examples, a computer-implemented method may include comparing, by the processing circuitry, information in each subsequent frame with the connection handle until the information corresponds with the connection handle and discarding, by the processing circuitry, each subsequent frame not having information corresponding with the connection handle.

In an eleventh example and in furtherance of any of the previous examples, a computer-implemented method may include validating, by the processing circuitry, the packet when second information in the first frame of the packet corresponds with a correct length for the packet.

In a twelfth example and in furtherance of any of the previous examples, a computer-implemented method may include determining, by the processing circuitry, whether information in subsequent frames corresponds with the connection handle on a frame-by-frame basis skipping remaining bytes in each subsequent frame when the information does not correspond with the connection handle.

In a thirteenth example and in furtherance of any of the previous examples, a computer-implemented method may include determining, by the processing circuitry, the connection handle for the connection from a connection response message to establish the communication session.

In a fourteenth example and in furtherance of any of the previous examples, a computer-implemented method may include the first frame comprising a header further comprising a 2 byte connection identifier field having the first information and a 1 byte length field having second information.

In a fifteenth example and in furtherance of any of the previous examples, a computer-implemented method may include establishing, by the processing circuitry, the communication session with a peripheral device and communicating, by the processing circuitry, with the peripheral device during the communication session via a radio.

In a sixteenth example and in furtherance of any of the previous examples, a computer-implemented method may include receiving the packets is in accordance with a host controller interface (HCl) transport layer standard.

In a seventeenth example and in furtherance of any of the previous examples, an article including non-transitory computer-readable storage medium having a plurality of instructions that when executed enable a processing component to receive a plurality of packets each comprising a number of frames, compare first information in a first frame of a packet with a connection handle established for a communication session, validate the packet when the first information corresponds with the connection handle and discard the first frame of the packet when the first information does not correspond with the connection handle.

In an eighteenth example and in furtherance of any of the previous examples, an article may include a plurality of instructions that when executed enable the processing component to compare information in each subsequent frame with the connection handle until the information corresponds with the connection handle and discard each subsequent frame not having information corresponding with the connection handle.

In a nineteenth example and in furtherance of any of the previous examples, an article may include a plurality of instructions that when executed enable the processing component to validate the packet when second information in the first frame of the packet corresponds with a correct length for the packet.

In twentieth example and in furtherance of any of the previous examples, an article may include a plurality of instructions that when executed enable the processing component to determine whether information in subsequent frames corresponds with the connection handle on a frame-by-frame basis skipping remaining bytes in each subsequent frame when the information does not correspond with the connection handle.

In a twenty-first example and in furtherance of any of the previous examples, an article may include a plurality of instructions that when executed enable the processing component to determine the connection handle for the connection from a connection response message to establish the communication session.

In a twenty-second example and in furtherance of any of the previous examples, an article may include the first frame comprising a header further comprising a 2 byte connection identifier field having the first information and a 1 byte length field having second information.

In a twenty-third example and in furtherance of any of the previous examples, an article may include a plurality of instructions that when executed enable the processing component to establish the communication session with a peripheral device and communicate with the peripheral device during the communication session via a radio.

In a twenty-fourth example and in furtherance of any of the previous examples, an article may include a plurality of instructions that when executed enable the processing component to receive the packets is in accordance with a host controller interface (HCl) transport layer standard.

In a twenty-fifth example and in furtherance of any of the previous examples, an apparatus may include means for receiving a plurality of packets each comprising a number of frame, means for comparing first information in a first frame of a packet with a connection handle established for a communication session, means for validating the packet when the first information corresponds with the connection handle and means for discarding the first frame of the packet when the first information does not correspond with the connection handle.

In a twenty-sixth example and in furtherance of any of the previous examples, an apparatus may include means for comparing information in each subsequent frame with the connection handle until the information corresponds with the connection handle and means for discarding each subsequent frame not having information corresponding with the connection handle.

In a twenty-seventh example and in furtherance of any of the previous examples, an apparatus may include means for validating the packet when second information in the first frame of the packet corresponds with a correct length for the packet.

In a twenty-eighth example and in furtherance of any of the previous examples, an apparatus may include means for determining whether information in subsequent frames corresponds with the connection handle on a frame-by-frame basis skipping remaining bytes in each subsequent frame when the information does not correspond with the connection handle.

In a twenty-ninth example and in furtherance of any of the previous examples, an apparatus may include means for determining the connection handle for the connection from a connection response message to establish the communication session.

In a thirtieth example and in furtherance of any of the previous examples, an apparatus may include means for establishing the communication session with a peripheral device and means for communicating with the peripheral device during the communication session via a radio.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. An apparatus, comprising:
processing circuitry;
a memory coupled with the processing circuitry to store a connection handle for a communication session;
a controller module comprising a radio to communicate information; and
a host stack module coupled with the controller module via an interface connection, the host stack module to:
receive packets from the controller module, each packet comprising a number of frames,
compare first information in a first frame of a packet with the connection handle stored in the memory, and
validate the packet when the first information corresponds with the connection handle, or discard the first frame when the first information does not correspond with the connection handle.

2. The apparatus of claim 1, the host stack module to compare information in each subsequent frame with the connection handle in the memory until the information corresponds with the connection handle, and discard each subsequent frame that does not have information corresponding with the connection handle.

3. The apparatus of claim 1, the host stack module to further validate the packet when second information in the first frame of the packet corresponds with a correct length for the packet.

4. The apparatus of claim 1, the host stack module to determine whether information in subsequent frames corresponds with the connection handle on a frame-by-frame basis skipping remaining bytes in each subsequent frame when the information does not correspond with the connection handle.

5. The apparatus of claim 1, the host stack module to determine the connection handle for the connection from a connection response message communicated to establish the communication session.

6. The apparatus claim 1, the first frame comprising a header further comprising a 2 byte connection identifier field having the first information and a 1 byte length field having second information.

7. The apparatus of claim 1, the controller module to establish the communication session with a peripheral device and communicate with the peripheral device during the communication session via the radio.

8. The apparatus of claim 1, the host stack module comprising a first interface and the controller module comprising a second interface, the first and second interfaces to communicate packets between the host stack module and the controller module in accordance with a host controller interface (HCl) transport layer standard.

9. A computer-implemented method, comprising:
receiving, by processing circuitry, packets each comprising a number of frames;
comparing, by the processing circuitry, first information in a first frame of a packet with a connection handle established for a communication session;
validating, by the processing circuitry, the packet when the first information corresponds with the connection handle; and
discarding, by the processing circuitry, the first frame of the packet when the first information does not correspond with the connection handle.

10. The computer-implemented method of claim 9, comprising:
comparing, by the processing circuitry, information in each subsequent frame with the connection handle until the information corresponds with the connection handle; and
discarding, by the processing circuitry, each subsequent frame not having information corresponding with the connection handle.

11. The computer-implemented method of claim 9, comprising:
validating, by the processing circuitry, the packet when second information in the first frame of the packet corresponds with a correct length for the packet.

12. The computer-implemented method of claim 9, comprising:
determining, by the processing circuitry, whether information in subsequent frames corresponds with the connection handle on a frame-by-frame basis skipping remaining bytes in each subsequent frame when the information does not correspond with the connection handle.

13. The computer-implemented method of claim 9, comprising:
determining, by the processing circuitry, the connection handle for the connection from a connection response message to establish the communication session.

14. The computer-implemented method of claim 9, the first frame comprising a header further comprising a 2 byte connection identifier field having the first information and a 1 byte length field having second information.

15. The computer-implemented method of claim 9, comprising:
establishing, by the processing circuitry, the communication session with a peripheral device; and
communicating, by the processing circuitry, with the peripheral device during the communication session via a radio.

16. The computer-implemented method of claim 9, wherein the receiving the packets is in accordance with a host controller interface (HCl) transport layer standard.

17. An article comprising non-transitory computer-readable storage medium comprising a plurality of instructions that when executed enable a processing component to:
receive a plurality of packets each comprising a number of frames;
compare first information in a first frame of a packet with a connection handle established for a communication session;
validate the packet when the first information corresponds with the connection handle; and
discard the first frame of the packet when the first information does not correspond with the connection handle.

18. The article of claim 17, comprising the plurality of instructions that when executed enable the processing component to:
compare information in each subsequent frame with the connection handle until the information corresponds with the connection handle; and
discard each subsequent frame not having information corresponding with the connection handle.

19. The article of claim 17, comprising the plurality of instructions that when executed enable the processing component to:
validate the packet when second information in the first frame of the packet corresponds with a correct length for the packet.

20. The article of claim 17, comprising the plurality of instructions that when executed enable the processing component to:
determine whether information in subsequent frames corresponds with the connection handle on a frame-by-frame basis skipping remaining bytes in each subsequent frame when the information does not correspond with the connection handle.

21. The article of claim 17, comprising the plurality of instructions that when executed enable the processing component to:
determine the connection handle for the connection from a connection response message to establish the communication session.

22. The article of claim 17, the first frame comprising a header further comprising a 2 byte connection identifier field having the first information and a 1 byte length field having second information.

23. The article of claim 17, comprising the plurality of instructions that when executed enable the processing component to:
establish the communication session with a peripheral device; and
communicate with the peripheral device during the communication session via a radio.

24. The article of claim 17, wherein the receiving the packets is in accordance with a host controller interface (HCl) transport layer standard.
